(19) United States
(12) Patent Application Publication
(10) Pub. No.: US 2009/0090452 A1
(43) Pub. Date: Apr. 9, 2009

(54) PROCESS FOR PRODUCING NONFLAT CERAMIC SUBSTRATE

(75) Inventors: Takayuki Naba, Kanagawa-ken (JP); Michiyasu Komatsu, Kanagawa-ken (JP); Takao Shirai, Kanagawa-ken (JP); Noritaka Nakayama, Kanagawa-ken (JP); Mitsuhiro Okamoto, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA MATERIALS CO., LTD.

(21) Appl. No.: 11/994,371

(22) PCT Filed: Jun. 26, 2006
(86) PCT No.: PCT/JP2006/312702

§ 371 Date: Dec. 31, 2007

(30) Foreign Application Priority Data
Jun. 29, 2005 (JP) 2005-190686

(51) Int. Cl. C04B 35/64; C04B 33/32; B32B 38/00; B05D 3/02

(52) U.S. Cl. 156/89.11; 264/678; 264/603; 427/372.2

(57) ABSTRACT

In the production of a ceramic substrate (1) with a level difference (3), a surface of a fired substrate obtained by firing of a ceramic green sheet is honed to form the level difference (3). Alternatively, a level difference is first formed through processing of a ceramic green sheet, laminating of a ceramic green sheet, or the like, and thereafter the ceramic green sheet is fired to obtain a fired substrate (ceramic substrate) (1) with a level difference (3).

### TECHNICAL FIELD

The present invention relates to a process for producing a ceramic substrate with a level difference.

### BACKGROUND ART

The ceramic substrate is used in various fields of circuit boards, package substrates, heat sinks and the like. It is used in various ways for a circuit board having a conductive layer such as a metallic plate, a conductive thin film, a conductive thick film and the like, a package having a complex shape, a heat sink of a module having a press-contacted structure, and the like.

As the material for the ceramic substrate, aluminum oxide (alumina: Al₂O₃), aluminum nitride (AlN), silicon nitride (Si₃N₄) and the like are mainly used. Alumina is inexpensive but has a low heat conductivity of about 20 W/m·K. Aluminum nitride provides high heat conductance with a heat conductivity of 200 W/m·K or more but often has a strength of about 300 to 400 MPa lower than alumina.

Accordingly, the silicon nitride substrate is being watched with interest in these years. For example, Patent Reference 1 describes a high heat conductive silicon nitride substrate having a heat conductivity of 70 W/m·K or more and a three point bending strength of 700 MPa or more. The high heat conductive silicon nitride substrate has a strength which is 2 times or more greater than alumina and AlN, but its heat conductivity is poor in comparison with AlN at present.

As described above, the ceramic substrate is used in various fields. The ceramic substrate is required to have the properties mainly including a heat radiation property and strength. It is general to use a single type of ceramic material to form a substrate, but the use of one type of material might not fully satisfy the requirement depending on what property is required. In such a case, for example, ceramic substrates of two or more types of different materials are combined as described in Patent Reference 2 or Patent Reference 3.

In a case where ceramic substrates of different materials are used in combination, their bonded portion has a simply contacted structure, namely a structure bonded by a resin adhesive or a metallic bonding material (e.g., a brazing material containing an active metal such as Ti or the like). A ceramic substrate to which the above bonded structure is applied has a bonded portion poor in strength, so that the above structure might not be applied depending on uses. In addition, since the bonded portion has a heat resistance in view of the heat radiation property, it causes to deteriorate the heat radiation property of the substrate as a whole.

The heat resistance depends on the heat conductivity and thickness of the substrate. Specifically, if the substrate has a high heat conductivity and a large thickness, the heat resistance increases, while if the substrate has a low heat conductivity and a small thickness, the heat resistance can be decreased. In other words, when the substrate has a high heat conductivity and a small thickness, the heat resistance lowers to minimum and the heat radiation property is improved. Therefore, it is attempted that a portion of the ceramic substrate formed of a single material, of which heat radiation property is desired to be improved, is formed thin, and a portion of which strength is desired to be increased is made thick. In other words, it is attempted to produce a ceramic substrate of which heat radiation property and strength are enhanced by forming a level difference on its surface.

A conventional ceramic substrate with a level difference is produced by performing mechanical polishing of a flat substrate surface by a diamond wheel or the like. But, the ceramic material is a hard-to-fabricate material, and a production method applying the mechanical polishing to form a level difference has a disadvantage that a ceramic substrate production cost is high. In addition, when a thin ceramic substrate having a thickness of 1 mm or less such as a circuit board is subjected to mechanical polishing, the substrate is easily cracked, and the production yield of the ceramic substrate with a level difference is also decreased.

[Patent Reference 1] JP-A 2000-34172 (KOKAI)

[Patent Reference 2] JP-A 09-121004 (KOKAI)

[Patent Reference 3] JP-A 10-065292 (KOKAI)

### SUMMARY OF THE INVENTION

The present invention provides a process for producing a ceramic substrate that has made it possible to produce a ceramic substrate with a level difference without performing mechanical polishing.

According to a first aspect of the invention, there is provided a process for producing a ceramic substrate with a level difference, comprising forming a ceramic green sheet, firing the ceramic green sheet to produce a fired substrate, and performing a honing treatment of a surface of the fired substrate to form a level difference.

According to a second aspect of the invention, there is provided a process for producing a ceramic substrate with a level difference comprises: forming a ceramic green sheet, processing the ceramic green sheet to produce a ceramic green sheet with a level difference, and firing the ceramic green sheet with the level difference to produce a fired substrate.

According to a third aspect of the invention, there is provided a process for producing a ceramic substrate with a level difference, comprising forming a first ceramic green sheet, forming a second ceramic green sheet having a size different from the first ceramic green sheet, laminating the second ceramic green sheet on the first ceramic green sheet to produce a ceramic green sheet with a level difference, and firing the ceramic green sheet with the level difference to produce a fired substrate.

According to a fourth aspect of the invention, there is provided a process for producing a ceramic substrate with a level difference, comprising forming a ceramic green sheet, coating ceramic paste on the ceramic green sheet to produce a ceramic green sheet with a level difference, and firing the ceramic green sheet with the level difference to produce a fired substrate.

According to a fifth aspect of the invention, there is provided a process for producing a ceramic substrate with a level difference, comprising forming a first ceramic green sheet, firing the first ceramic green sheet to produce a fired substrate, forming a second ceramic green sheet having a size different from the first ceramic green sheet, laminating the second ceramic green sheet on the fired substrate, and firing the fired substrate again.

### BRIEF DESCRIPTION OF THE DRAWINGS

FIG. 1 is a perspective view showing an example of a ceramic substrate with a level difference.

FIG. 2 is a plan view of the ceramic substrate shown in FIG. 1.

FIG. 3 is a sectional view of the ceramic substrate shown in FIG. 1.

FIG. 4 is a perspective view showing another example of a ceramic substrate with a level difference.

FIG. 5 is a plan view of the ceramic substrate shown in FIG. 4.

FIG. 6 is a sectional view of the ceramic substrate shown in FIG. 4.

FIG. 7 is a plan view showing a modified example of the ceramic substrate shown in FIG. 1.

FIG. 8 is a plan view showing a modified example of the ceramic substrate shown in FIG. 4.

FIG. 9 is a plan view showing another modified example of the ceramic substrate shown in FIG. 4.

FIG. 10 is a sectional view showing another example of a ceramic substrate with level differences.

FIG. 11 is a sectional view showing another example of a ceramic substrate with level differences.

FIG. 12 is a sectional view showing another example of a ceramic substrate with level differences.

FIG. 13 is a sectional view showing another example of a ceramic substrate with level differences.

FIG. 14 is a sectional view showing another example of a level difference formed on a surface of a ceramic substrate.

FIG. 15 is a sectional view showing a still another example of a level difference formed on a surface of a ceramic substrate.

FIG. 16 is a sectional view showing a still another example of a level difference formed on a surface of a ceramic substrate.

### EXPLANATION OF NUMERALS

1 . . . Ceramic substrate, 2 . . . projected portion, 3 . . . level difference.

### MODE FOR CARRYING OUT THE INVENTION

Modes of conducting the present invention will be described below with reference to the drawings. Embodiments of the present invention are described with reference to the drawings, which are provided for illustration only, and the present invention is not limited to the drawings.

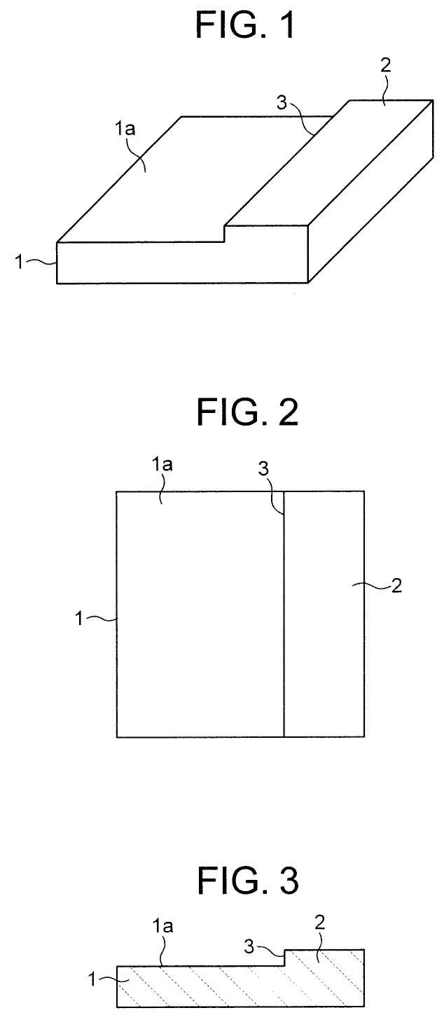

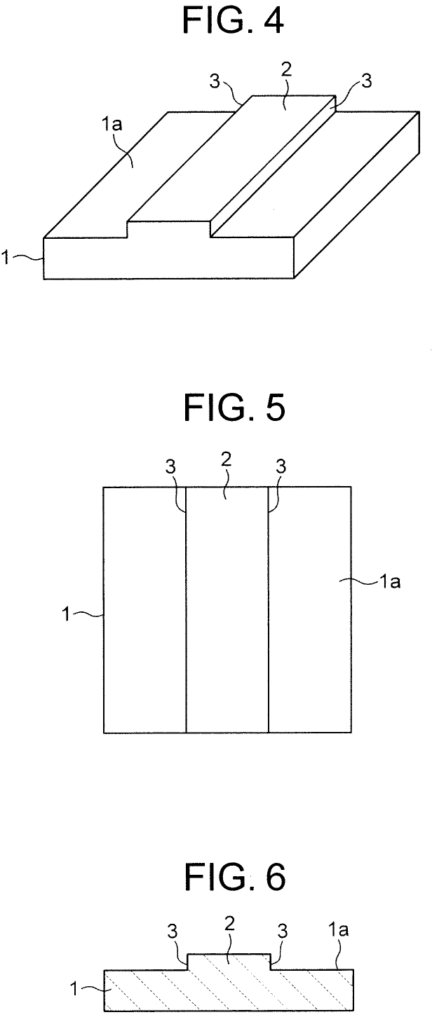

The production process according to the invention is a process for producing a ceramic substrate with a level difference. Examples of the ceramic substrate with a level difference will be described with reference to FIG. 1 through FIG. 13. A ceramic substrate 1 shown in FIG. 1, FIG. 2 and FIG. 3 has a projected portion 2 formed at one end of its surface 1a. A level difference 3 is formed based on the projected portion 2 on the surface 1a of the ceramic substrate 1. The ceramic substrate 1 shown in FIG. 4, FIG. 5 and FIG. 6 has the projected portion 2 which is formed near the center of the surface 1a. Level differences 3, 3 are formed at both sides of the projected portion 2 which is formed near the center of the surface 1a of the ceramic substrate 1.

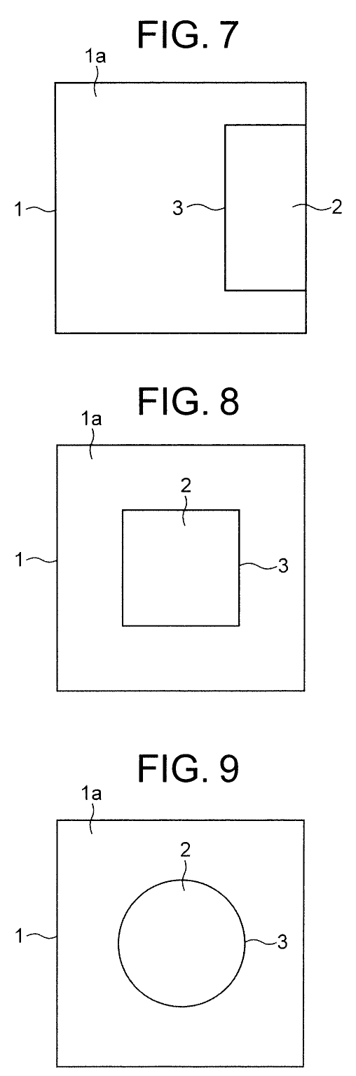

The projected portion 2 and the level difference 3 based on the projected portion 2 are not limited to a particular shape and formed position. As described above, the projected portion 2 and the level difference 3 based on the projected portion 2 can be formed at any position on the surface 1a of the ceramic substrate 1. In a case where the projected portion 2 is formed at an end of the surface 1a, the projected portion 2 may have a shape as shown in FIG. 7. In a case where the projected portion 2 is formed near the center of the surface 1a, it may be a rectangular projected portion 2 shown in FIG. 8 or a circular projected portion 2 shown in FIG. 9. In any event, the level difference 3 is formed based on the projected portion 2 on the surface 1a of the ceramic substrate 1.

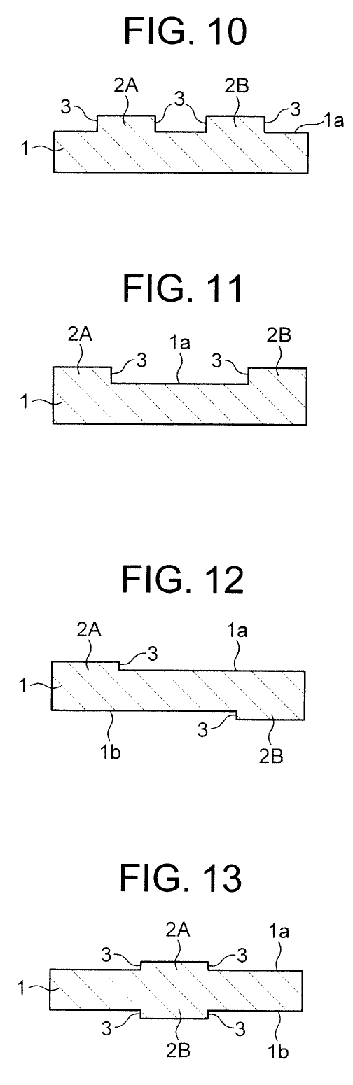

The ceramic substrates 1 shown in FIG. 1 through FIG. 9 have one projected portion 2 on the surface 1a and the level difference(s) 3 based on the one projected portion 2. The number of the projected portion 2 and the surface on which the projected portion 2 is formed are not limited to those described above. For example, the ceramic substrate 1 may have plural projected portions 2, and the projected portion 2 may be formed on both surfaces of the ceramic substrate 1 as shown in FIG. 10 through FIG. 13. The production process according to the embodiment of the invention is applied to the production of the ceramic substrate 1 with the level difference 3 based on such various types of projected portions 2.

The ceramic substrate 1 shown in FIG. 10 and FIG. 11 has two projected portions 2A, 2B which are formed on the surface 1a, and the level differences 3 are formed on the surface 1a based on the two projected portions 2A, 2B. The ceramic substrates 1 shown in FIG. 12 and FIG. 13 have the projected portion 2A on the surface 1a and the projected portion 2B on another surface 1b, and the individual surfaces 1a, 1b are provided with the level differences 3 based on the two projected portions 2A, 2B. FIG. 10 through FIG. 13 show the ceramic substrate 1 having two projected portions 2A, 2B, but it is needless to say that the number of the projected portions 2 may be three or more.

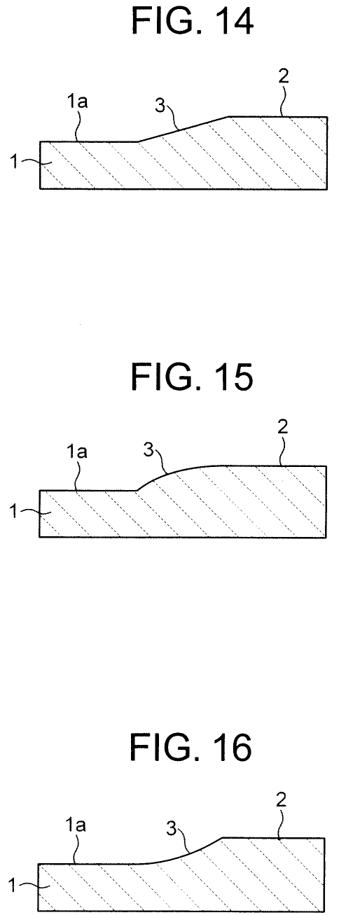

In addition, the shapes of the level differences 3 are not limited to the level differences (level differences having a vertical surface) 3 which are based on the projected portion 2 having a rectangular cross section as shown in FIG. 1 through FIG. 13. For example, the level difference 3 may have an inclined surface between the surface 1a and the projected portion 2 as shown in FIG. 14. The surface 1a and the projected portion 2 may also have the level difference 3 having a curved surface (a convex curved surface, a concave curved surface or the like) between them as shown in FIG. 15 and FIG. 16. In a case where the level difference 3 having a curved surface is applied, it is preferable that an R shaped cross section has R0.2 mm or more or C0.2 mm or more.

Thus, the ceramic substrate 1 with the level difference 3 is not limited to a particular shape, and it is sufficient if there is at least one level difference 3 on at least one surface. The level difference 3 can have various types of shapes such as a vertical surface, an inclined surface, a curved surface and the like. The position where the level difference 3 is formed is arbitrary and may be an end or the vicinity of the center of the surface of the ceramic substrate 1. In addition, the level difference 3 is not limited to formation on the front surface of the ceramic substrate 1 but may be formed on the back surface. The ceramic substrate 1 with the level difference 3 is sufficient if it has at least one level difference 3, and the number, formed position, shape and the like of the level difference 3 can be determined arbitrarily.

The production process according to the invention is a process for production of a ceramic substrate with the level difference as described above. The production processes of a ceramic substrate with a level difference according to embodiments of the invention will be described in detail below. In the description of individual steps in the production processes of the ceramic substrates with a level difference, the same step codes are used to indicate the substantially same steps in the individual embodiments.

A process for producing a ceramic substrate with a level difference according to a first embodiment comprises:

step A: forming a ceramic green sheet,
step B: firing the ceramic green sheet to form a fired substrate (ceramic substrate), and
step C: performing a honing treatment of a surface of the fired substrate (ceramic substrate) to form a level difference.

First, ceramic powder as a main component, and if necessary, a sintering aid powder, a resin binder and a solvent are mixed at a prescribed ratio to produce ceramics paste. In step A, the ceramics paste is used to form a ceramic green sheet. To form the ceramic green sheet, various forming methods such as a die-pressing method, a doctor-blade method, and the like can be applied. If the ceramic substrate is thin and has a thickness of 1 mm or less, the doctor-blade method is preferably applied.

Then, in step B, the ceramic green sheet is fired to produce a fired substrate. Firing conditions (temperature, time, atmosphere, etc.) are selected appropriately depending on the ceramic material as the main component. Then, in step C, the surface of the fired substrate is subjected to a honing treatment to form a level difference. The production process applying the honing treatment is effective when a relatively small level difference having a height of 0.6 mm or less is formed.

The honing treatment is preferably performed using ceramic abrasive grain. At that time, a honing pressure is preferably 0.4 MPa or more. The upper limit of the honing pressure is selected appropriately depending on the strength of the material. But, if the honing pressure is higher more than necessary, the substrate is cracked or chipped, and there is a possibility that the yield is decreased. For example, the honing pressure is preferably determined to be 2 MPa or less for an alumina substrate or AlN substrate which has a low strength and to be 3 MPa or less for a silicon nitride substrate which has a high strength.

A process for producing a ceramic substrate with a level difference according to a second embodiment comprises:

step A: forming a ceramic green sheet,
step D: processing the green sheet to produce a ceramic green sheet with a level difference, and
step B: firing the ceramic green sheet with the level difference to produce a fired substrate (ceramic substrate) with a level difference.

Step A and step B are substantially same as those of the production process according to the first embodiment. In the production process according to the second embodiment, the level difference forming step becomes step D. In other words, the ceramic green sheet is processed to form a level difference on the ceramic green sheet and therefore on the ceramic substrate. Since the ceramic green sheet before firing can be processed easily, the production cost and production yield can be improved substantially.

The production process applying the processing into the ceramic green sheet is effective to form a relatively large level difference having a height of 0.7 mm or more. The upper limit of the level difference is not particularly limited but preferably 1 mm or less considering productivity and the like. In a case where a substrate with a level difference having a height exceeding 1 mm is produced, a process for multilayering a sheet having a thickness of 1 mm or less is also effective. This is not limited to the process for processing the ceramic green sheet but can also be applied to the process for laminating the ceramic green sheet.

A process for producing a ceramic substrate with a level difference according to a third embodiment comprises:

step A: forming a first ceramic green sheet and a second ceramic green sheet having a size different from that of the first,
step E: laminating the second green sheet on the first green sheet to produce a ceramic green sheet with a level difference, and
step B: firing the ceramic green sheet with the level difference to produce a fired substrate (ceramic substrate) with a level difference.

Here, two types of ceramic green sheets are produced in step A, but the specific green sheet production step itself is substantially same as in the first embodiment. Step B is also substantially same as in the first embodiment. In the production process according to the third embodiment, the level difference forming step becomes step E. Specifically, for example, the second ceramic green sheet smaller than the first ceramic green sheet is laminated on the first ceramic green sheet to form a level difference on the ceramic green sheet and therefore on the ceramic substrate. The production process applying the lamination of the ceramic green sheets is effective for production of a substrate having a large thickness and a substrate having a large size in length and width.

A process for producing a ceramic substrate with a level difference according to a fourth embodiment comprises:

step A: forming a ceramic green sheet,
step F: coating ceramic paste on the ceramic green sheet to form a size larger than the ceramic green sheet to produce a ceramic green sheet with a level difference, and
step B: firing the ceramic green sheet with the level difference to produce a fired substrate (ceramic substrate) with a level difference.

Step A and step B are substantially same as those of the first embodiment. In the production process according to the fourth embodiment, the level difference forming step becomes step F. Specifically, ceramic paste is coated on the ceramic green sheet to have a size larger than the ceramic green sheet to form a level difference on the ceramic green sheet and therefore on the ceramic substrate. Since the ceramic paste is used, the process is not suitable for formation of a relatively large level difference, but the simple step of coating the ceramic paste is effective to form plural projected portions.

A process for producing a ceramic substrate with a level difference according to a fifth embodiment comprises:

step A: forming a first ceramic green sheet and a second ceramic green sheet having a size different from the first ceramic green sheet,
step B: firing the first ceramic green sheet to produce a fired substrate (ceramic substrate),
step G: laminating the second ceramic green sheet having a different size on the fired substrate (ceramic substrate), and
step H: firing the fired substrate again to produce a ceramic substrate with a level difference.

Here, two types of ceramic green sheets are produced in step A, but the specific green sheet production step itself is substantially same as in the first embodiment. Step B is also substantially same as in the first embodiment. In the production process according to the fifth embodiment, the level difference forming step becomes step G and step H. In other words, the ceramic substrate with the level difference is produced by laminating the ceramic green sheet on the fired substrate and firing again. Since the fired substrate is used, the process is suitable to form the level difference on a thin ceramic substrate (e.g., 0.3 mm or less).

According to any of the production processes of the first to fifth embodiments described above, the level difference can be formed on the ceramic substrate without performing mechanical polishing (polishing by a diamond wheel or the like). The ceramic substrate obtained by the production process of the each embodiment is an unpolished substrate which has not been undergone the mechanical polishing, so that the production cost of the ceramic substrate with the level difference can be reduced. In addition, since a strong stress is not applied to the substrate like the mechanical polishing, a production yield of the ceramic substrate with the level difference can be improved.

The thickness of the ceramic substrate produced by the production process according to the each embodiment is arbitrary, and good production yield can also be obtained when the each production process is applied to the production of a thin substrate having a thickness of 1 mm or less and particularly 0.5 mm or less. In a case where various-sized level differences ranging from a small level difference having a height of 0.3 to 0.6 mm to a large level difference having a height of 0.7 mm or more are formed alone or in plural (two or more), the production yield of the ceramic substrate with a level difference can be improved. The first through fifth embodiments may be combined if necessary.

According to the production processes of the first through fifth embodiments described above, it is determined that a surface roughness in an arbitrary direction on the surface having a level difference is Ra1 and a surface roughness orthogonal to the direction is Ra2, and a ceramic substrate having a value of Ra1/Ra2 in a range of 0.8 to 1.2 can be obtained. When mechanical polishing is performed, the surface roughness has directionality, and Ra1/Ra2 does not fall in the range of 0.8 to 1.2. When an unpolished substrate having Ra1/Ra2 of 0.8 to 1.2 is used, a bending strength property, a heat-cycle resistance (TCT) property and the like can be improved as described in JP-A 2002-171037 (KOKAI).

The ceramic substrates produced by the production processes according to the embodiments of the invention have a level difference, so that a portion of which strength is desired to be improved can be made thick, and a portion of which heat radiation property is desired to be improved can be made thin. Accordingly, it becomes possible to provide a ceramic substrate complying with various demanded properties. Such a ceramic substrate with a level difference is suitable for a ceramic circuit board having a conductive layer such as a metallic plate, a conductive thin film, a conductive thick film (a metallized layer formed by firing paste or the like) or the like, a complex-shaped package substrate with plural level differences (projected portions), and a heat sink (or a circuit board) to which a stress is applied as if it has a press-contacted structure.

The material of the ceramic substrate is not limited to a particular one. It can be applied to a ceramic substrate having a main component of aluminum oxide, aluminum nitride or silicon nitride, and a silicon nitride substrate is preferable. As described above, the heat resistance affecting the heat radiation property is determined depending on the heat conductivity of the material and the thickness of the substrate. For example, an aluminum nitride substrate having a heat conductivity of 200 W/m·K or more has been developed but its strength is low and therefore it is hardly used for a press-contacted structure or in a field in which addition of a heat cycle is large. An aluminum oxide substrate has a strength of about 400 to 500 MPa and a low heat conductivity of about 20 W/m·K, so that it is hard to decrease the heat resistance sufficiently.

Meanwhile, a silicon nitride substrate having a heat conductivity of 70 W/m·k or more, a strength of 700 MPa or more and high heat conductance and strength has been developed as described in Patent Reference 1 and the like. Since the silicon nitride substrate has high strength, it can also be applied to a press-contacted structure and a field in which addition of a heat cycle is large. In addition, a portion of which heat radiation property is desired to be improved can be made thin to decrease the heat resistance. The silicon nitride substrate has a high strength as a material, so that the strength can be maintained even if the substrate thickness is made thin to 0.1 to 0.3 mm. Therefore, the silicon nitride substrate is desirable as the ceramic substrate.

Specific examples of the invention and their evaluated results will be described below.

### EXAMPLE 1

First, silicon nitride substrates having a heat conductivity of 70 W/m·K, a three point bending strength of 800 MPa and a thickness of 0.32 mm were prepared. Those silicon nitride substrates were obtained by firing a green sheet. The silicon nitride substrates were subjected to a honing treatment to produce the ceramic substrates with the level difference shown in FIG. 1 through FIG. 3.

The honing treatment was performed using ceramic abrasive grain. A honing pressure was 0.5 MPa. The silicon nitride substrates were undergone the honing treatment under the above conditions to produce ceramic substrates with a level difference shown in Table 1. Heat resistance and production yield were examined. Ra1/Ra2 was also measured. The obtained results are shown in Table 1.

TABLE 1

| | | | Size of level | | | |
|---|---|---|---|---|---|---|
| | | | difference | Heat | | |
| | | | [Length × width × | resistance | Yield | |
| | | Honing conditions | thickness (mm)] | (K/W) | (%) | Ra1/Ra2 |
| Ex. 1 | Sample 1 | Alumina abrasive | 30 × 30 × 0.2 | 0.15 | 92 | 1.01 |
| | | grain/0.5 MPa | | | | |
| | Sample 2 | ZrO₂ abrasive | 30 × 30 × 0.2 | 0.14 | 93 | 0.98 |
| | | grain/0.5 MPa | | | | |

Ex. = Example

### EXAMPLE 2

A green sheet was prepared as a material for an aluminum nitride substrate having a heat conductivity of 200 W/m-K, a three point bending strength of 350 MPa and a thickness of 0.635 mm. The green sheet was processed to produce green sheets with a level difference. The level difference had a shape as shown in FIG. 1 through FIG. 3. The green sheets with the level difference were fired under prescribed conditions to produce ceramic substrates with a level difference shown in Table 2. Heat resistance and production yield were examined. Ra1/Ra2 was also measured. The obtained results are shown in Table 2.

TABLE 2

| | | Size of level | | | |
|---|---|---|---|---|---|
| | | difference | Heat | | |
| | | [Length × width × | resistance | Yield | |
| | | thickness (mm)] | (K/W) | (%) | Ra1/Ra2 |
| Ex. 2 | Sample 3 | 30 × 30 × 0.2 | 0.10 | 91 | 1.02 |
| | Sample 4 | 30 × 30 × 0.15 | 0.09 | 92 | 1.01 |

Ex. = Example

### EXAMPLE 3

A green sheet was prepared as a material for a silicon nitride substrate having a heat conductivity of 80 W/m·K, a three point bending strength of 850 MPa and a thickness of 0.32 mm. A first green sheet had a length of 50 mm and a width of 50 mm, and a second green sheet (having the same composition) having a different size was laminated thereon to produce a green sheet with a level difference. The level difference had the shape shown in FIG. 1 through FIG. 3. The green sheet with the level difference was fired under prescribed conditions to produce ceramic substrates with a level difference shown in Table 3. Heat resistance and production yield were examined. Ra1/Ra2 was also measured. The obtained results are shown in Table 3.

TABLE 3

| | | Size of level | | | |
|---|---|---|---|---|---|
| | | difference | Heat | | |
| | | [Length × width × | resistance | Yield | |
| | | thickness (mm)] | (K/W) | (%) | Ra1/Ra2 |
| Ex. 3 | Sample 5 | 30 × 30 × 0.2 | 0.12 | 89 | 1.08 |
| | Sample 6 | 30 × 30 × 0.15 | 0.11 | 91 | 1.05 |

Ex. = Example

### EXAMPLE 4

A green sheet was prepared as a material for a silicon nitride substrate having a heat conductivity of 90 W/m·K, a three point bending strength of 830 MPa and a thickness of 0.32 mm. Paste of the same composition was coated on the green sheet to produce green sheets with a level difference. The level difference had a shape as shown in FIG. 4 through FIG. 6. The green sheets with the level difference were fired under prescribed conditions to produce ceramic substrates with a level difference shown in Table 4. Heat resistance and production yield were examined. Ra1/Ra2 was also measured. The obtained results are shown in Table 4.

TABLE 4

| | | Size of level | | | |
|---|---|---|---|---|---|
| | | difference | Heat | | |
| | | [Length × width × | resistance | Yield | |
| | | thickness (mm)] | (K/W) | (%) | Ra1/Ra2 |
| Ex. 4 | Sample 7 | 30 × 30 × 0.05 | 0.12 | 88 | 1.07 |
| | Sample 8 | 30 × 30 × 0.03 | 0.11 | 91 | 1.02 |
| | Sample 9 | 30 × 30 × 0.01 | 0.10 | 91 | 1.04 |

Ex. = Example

### EXAMPLE 5

A silicon nitride substrate having a heat conductivity of 90 W/m·K, a three point bending strength of 830 MPa and a thickness of 0.32 mm was prepared. This silicon nitride substrate was obtained by firing a green sheet. A green sheet (having the same composition) having a different size was laminated on the silicon nitride substrate. The level difference had a shape as shown in FIG. 4 through FIG. 6. Firing was performed again under prescribed conditions to produce ceramic substrates with a level difference shown in Table 5. Heat resistance and production yield were examined. Ra1/Ra2 was also measured. The obtained results are shown in Table 4.

TABLE 5

| | | Size of level | | | |
|---|---|---|---|---|---|
| | | difference | Heat | | |
| | | [Length × width × | resistance | Yield | |
| | | thickness (mm)] | (K/W) | (%) | Ra1/Ra2 |
| Ex. 5 | Sample 10 | 30 × 30 × 0.3 | 0.12 | 92 | 1.02 |
| | Sample 11 | 30 × 30 × 0.2 | 0.11 | 93 | 1.02 |
| | Sample 12 | 30 × 30 × 0.15 | 0.10 | 94 | 0.99 |

Ex. = Example

### COMPARATIVE EXAMPLES 1 AND 2

First, as Comparative Example 1, a silicon nitride substrate having the same shape and size as sample 1 of Example 1 was produced by applying mechanical polishing using a diamond wheel. As Comparative Example 2, an aluminum nitride substrate having the same shape and size as sample 4 of Example 2 was produced by applying mechanical polishing using a diamond wheel. Production yields were examined. Ra1/Ra2 was also measured. The obtained results are shown in Table 6.

TABLE 6

| | Yield | |
|---|---|---|
| | (%) | Ra1/Ra2 |
| Comparative | 67 | 1.30 |
| Example 1 | | |
| Comparative | 71 | 1.25 |
| Example 2 | | |

### EXAMPLE 6, COMPARATIVE EXAMPLES 3 AND 4

Silicon nitride substrates with a level difference were produced in the same manner as in Example 3 excepting that the silicon nitride substrate of sample 7 of Example 3 was changed to have a base substrate thickness of 0.1 mm (sample 13) and 0.2 mm (sample 14). In addition, silicon nitride substrates (Comparative Examples 3, 4) having the same shape and size as sample 13 and sample 14 were produced by applying mechanical polishing using a diamond wheel. Heat resistance and production yield were examined. Ra1/Ra2 was also measured. The obtained results are shown in Table 7.

TABLE 7

| | | | Size of level | | | |
|---|---|---|---|---|---|---|
| | | Thickness of | difference | Heat | | |
| | | base substrate | [Length × width × | resistance | Yield | |
| | | (mm) | thickness (mm)] | (K/W) | (%) | Ra1/Ra2 |
| Ex. 6 | Sample 13 | 0.1 | 30 × 30 × 0.2 | 0.11 | 86 | 1.07 |
| | Sample 14 | 0.2 | 30 × 30 × 0.2 | 0.11 | 88 | 1.08 |

| | | | | | |
|---|---|---|---|---|---|
| C. Ex. 3 | 0.1 | 30 × 30 × 0.2 | 0.11 | 50 | 1.33 |
| C. Ex. 4 | 0.2 | 30 × 30 × 0.2 | 0.11 | 55 | 1.32 |

Ex. = Example,
C. Ex. = Comparative Example

It is apparent from Table 7 that when the thin substrates of Comparative Examples 3 and 4 are subjected to mechanical polishing, lots of substrate cracks are caused and the yield is lowered. Meanwhile, according to the production process of the example, the ceramic substrate with a level difference can be produced without involving the reduction of the yield.

### EXAMPLE 7, COMPARATIVE EXAMPLES 5 AND 6

A silicon nitride substrate (sample 15) having two projected portions shown in FIG. 10 was produced in the same manner as in Example 4. A silicon nitride substrate (sample 16) having two projected portions shown in FIG. 11 was produced in the same manner as in Example 5. Silicon nitride substrates (Comparative Examples 5, 6) having the same shape and size as those of sample 13 and sample 14 were produced by applying mechanical polishing using a diamond wheel. Heat resistance and production yield were examined. Ra1/Ra2 was also measured. The obtained results are shown in Table 8.

TABLE 8

| | | | Size of level | | | |
|---|---|---|---|---|---|---|
| | | Thickness of | difference | Heat | | |
| | | base substrate | [Length × width × | resistance | Yield | |
| | | (mm) | thickness (mm)] | (K/W) | (%) | Ra1/Ra2 |
| Ex. 7 | Sample 15 | 0.32 | 30 × 30 × 0.05 | 0.12 | 87 | 1.07 |
| | Sample 16 | 0.32 | 30 × 30 × 0.3 | 0.12 | 90 | 1.02 |

| | | | | | |
|---|---|---|---|---|---|
| C. Ex. 5 | 0.32 | 30 × 30 × 0.05 | 0.12 | 54 | 1.30 |
| C. Ex. 6 | 0.32 | 30 × 30 × 0.3 | 0.12 | 58 | 1.31 |

Ex. = Example,
C. Ex. = Comparative Example

It is apparent from Table 8 that a ceramic substrate with plural projected portions and plural level differences based on them can be produced with good yield according to the production process of the example.

The production process according to the invention is not limited to the embodiments described above but can also be applied to the production of ceramic substrates with various shapes of level differences. In addition, various modifications and variations of the embodiments of the invention may be made within the technical scope of the present invention. And, the modified or altered embodiments are also included in the technical scope of the present invention.

### INDUSTRIAL APPLICABILITY

The process for producing a ceramic substrate according to the invention does not perform mechanical polishing, so that the ceramic substrate with a level difference can be provided at a low cost. In addition, the production yield of the ceramic substrate with the level difference can be improved because a strong stress is not added like the mechanical polishing. The process for producing a ceramic substrate according to the invention is applied to the production of a ceramic substrate with a level difference for various types of usages.

1. A process for producing a ceramic substrate with a level difference, comprising:
forming a ceramic green sheet;
firing the ceramic green sheet to produce a fired substrate; and
performing a honing treatment of a surface of the fired substrate to form a level difference having a height of 0.3 to 0.6 mm.

2. The process according to claim 1, wherein a surface roughness in any direction on the surface having the level difference of the fired substrate is Ra1, a surface roughness orthogonal to the direction is Ra2, and Ra1/Ra2 is in a range of 0.8 to 1.2.

3. The process according to claim 1, wherein the ceramic substrate with the level difference is an unpolished substrate.

4. The process according to claim 1, wherein the ceramic substrate is a silicon nitride substrate.

5. A process for producing a ceramic substrate with a level difference, comprising:
forming a ceramic green sheet;
processing the ceramic green sheet to produce a ceramic green sheet with a level difference; and
firing the ceramic green sheet with the level difference to produce a fired substrate with a level difference having a height of 0.7 mm or more.

6. The process according to claim 5, wherein a surface roughness in any direction on the surface having the level difference of the fired substrate is Ra1, a surface roughness orthogonal to the direction is Ra2, and Ra1/Ra2 is in a range of 0.8 to 1.2.

7. The process according to claim 5, wherein the ceramic substrate with the level difference is an unpolished substrate.

8. The process according to claim 5, wherein the ceramic substrate is a silicon nitride substrate.

9. A process for producing a ceramic substrate with a level difference, comprising:
forming a first ceramic green sheet;
forming a second ceramic green sheet having a size different from the first ceramic green sheet;
laminating the second ceramic green sheet on the first ceramic green sheet to produce a ceramic green sheet with a level difference; and
firing the ceramic green sheet with the level difference to produce a fired substrate with a level difference having a height of 0.7 mm or more.

10. The process according to claim 9, wherein a surface roughness in any direction on the surface having the level difference of the fired substrate is Ra1, a surface roughness orthogonal to the direction is Ra2, and Ra1/Ra2 is in a range of 0.8 to 1.2.

11. The process according to claim 9, wherein the ceramic substrate with the level difference is an unpolished substrate.

12. The process according to claim 9, wherein the ceramic substrate is a silicon nitride substrate.

13. A process for producing a ceramic substrate with a level difference, comprising:
forming a ceramic green sheet;
coating ceramic paste on the ceramic green sheet to produce a ceramic green sheet with a plurality of level differences; and
firing the ceramic green sheet with the level differences to produce a fired substrate with a plurality of level differences.

14. The process according to claim 13, wherein a surface roughness in any direction on the surface having the level difference of the fired substrate is Ra1, a surface roughness orthogonal to the direction is Ra2, and Ra1/Ra2 is in a range of 0.8 to 1.2.

15. The process according to claim 13, wherein the ceramic substrate with the level difference is an unpolished substrate.

16. The process according to claim 13, wherein the ceramic substrate is a silicon nitride substrate.

17. A process for producing a ceramic substrate with a level difference, comprising:
forming a first ceramic green sheet;
firing the first ceramic green sheet to produce a fired substrate having a thickness of 0.3 mm or less;
forming a second ceramic green sheet having a size different from the first ceramic green sheet;
laminating the second ceramic green sheet on the fired substrate; and
firing the fired substrate again.

18. The process according to claim 17, wherein a surface roughness in any direction on the surface having the level difference of the fired substrate is Ra1, a surface roughness orthogonal to the direction is Ra2, and Ra1/Ra2 is in a range of 0.8 to 1.2.

19. The process according to claim 17, wherein the ceramic substrate with the level difference is an unpolished substrate.

20. The process according to claim 17, wherein the ceramic substrate is a silicon nitride substrate.
